(19) United States
(12) Patent Application Publication
(10) Pub. No.: US 2010/0048268 A1
(43) Pub. Date: Feb. 25, 2010

(54) MOBILE DEVICE ACCESSORIES AND METHODS OF ATTACHMENT TO MOBILE DEVICES

(76) Inventors: Patrick O'Neill, Huntington Beach, CA (US); Roger Butterworth, Wilmslow Cheshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 12/540,276

(22) Filed: Aug. 12, 2009

Related U.S. Application Data
(60) Provisional application No. 61/090,524, filed on Aug. 20, 2008.

(51) Int. Cl. H04M 1/00

(52) U.S. Cl. 455/575.8

(57) ABSTRACT

A mobile device accessory for attachment to a mobile device can include both an attachment portion as well as an accessory portion. In some embodiments, the attachment portion can comprise a battery cover or replica battery cover. Further, the accessory portion can comprise a flexible cover configured to remain on the phone during use and protect the outside of the mobile device when closed.

### CLAIM OF PRIORITY

This application claims benefit under 35 U.S.C. 119(e) to U.S. Provisional Patent Application No. 61/090,524, filed Aug. 20, 2008, which is incorporated in its entirety by reference herein.

### FIELD OF THE INVENTION

The present application is directed generally toward mobile device accessories, and specifically toward devices and methods for attaching mobile devices to accessories.

### DESCRIPTION OF THE RELATED ART

Many different types of mobile device accessories are used by consumers, and include, for example, covers for mobile phones or digital assistants. These covers often function to protect portions of the phone from environmental or user wear. The covers can also help prevent dirt or debris from lodging within grooves, cracks, or other small areas along the surfaces of the phone. Some mobile phone covers are also designed to slip onto a mobile phone and cover an area or areas of the phone that are frequently contacted by a user, such as the keypad or display, to diminish the risk of inadvertent button contact. However, in some cases, the covers include protective barriers, such as transparent plastic films, or large attachment areas between the cover and the mobile device on the rear, sides, or front of the mobile device that interfere with or compromise ease of accessing, viewing, or otherwise communicating through the device.

### SUMMARY OF THE INVENTION

In accordance with some embodiments disclosed herein, a mobile device accessory can comprise an attachment portion and an accessory portion. The attachment portion can comprise a replica mobile device component that has a shape or structure similar in at least some respects to an original, removable mobile device component, such as a battery cover. The replica mobile device component can be configured to attach to the mobile device in an area of the mobile device where the original mobile device component is normally located.

Further, in accordance with some embodiments disclosed herein, a mobile device accessory can comprise an attachment portion configured to replace an existing component on a mobile device, and an accessory portion that temporarily covers some, all, or substantially all of a mobile device in a first configuration, but that opens to expose at least certain portions of the mobile device that are designed for direct user contact, input, or other access in an unobstructed way. In some embodiments, the accessory portion can comprise a thin, flexible cover which substantially covers and protects virtually the entire mobile device when the mobile device is not in use. The cover portion can be configured to flex, bend, or otherwise move so as to allow access to the user portions of the mobile device when the mobile device is in use.

In some embodiments disclosed herein, mobile device accessories can be less bulky and permit easier access to the underlying mobile devices by providing smaller or fewer attachment points or surfaces as compared, for example, with current mobile phone covers.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a perspective view of an embodiment of a mobile device accessory and mobile device.

FIG. 2 is an exploded perspective view of the mobile device accessory and mobile device of FIG. 1.

FIGS. 3a and 3b are perspective views of an embodiment of a mobile device accessory and mobile device, in both a closed and open state.

FIG. 4 is an exploded perspective view of an embodiment of the mobile device accessory and mobile device of FIG. 3.

FIG. 5 is a front perspective view of an embodiment of a mobile device accessory and mobile device.

FIG. 6 is a rear perspective view of the mobile device accessory and mobile device of FIG. 5.

FIG. 7 is a perspective view of an embodiment of a mobile device accessory and mobile device, illustrating one direction in which a portion of the mobile device accessory can move.

FIG. 8 is a front, exploded perspective view of the mobile device accessory and mobile device of FIG. 7.

FIG. 9 is a rear, exploded perspective view of the mobile device accessory and mobile device of FIG. 7.

FIG. 10 is a perspective view of an embodiment of a mobile device accessory and mobile device.

FIG. 11 is an exploded front and rear perspective view of the mobile device accessory and mobile device of FIG. 10.

FIG. 12 is an exploded perspective view of an embodiment of a mobile device accessory and mobile device.

FIG. 13 is a perspective view of the mobile device of FIG. 12, including a removable SIM card holder.

FIG. 14 is right-side elevational view of the mobile device of FIG. 12 with the SIM card holder inserted into the mobile device.

FIG. 15 is a perspective view of the mobile device accessory and mobile device of FIG. 12.

### DETAILED DESCRIPTION OF THE PREFERRED EMBODIMENTS

For convenience, the embodiments disclosed herein are described in the context of a mobile phone cover. However, the embodiments can also comprise other types of mobile device accessories configured for other uses, such as holsters, base-stations for land-line or network consoles, connectors for other accessories, or covers or cases for personal data assistants, lap-top computers, GPS units, MP3 players, DVD players, bar-code readers, scientific instruments, and any other type of data receiving and/or data gathering device.

Various features associated with different embodiments will be described below. All of the features of each embodiment, individually or together, can be combined with features of other embodiments, which combinations form part of this disclosure. Further, no feature is critical or essential to any embodiment.

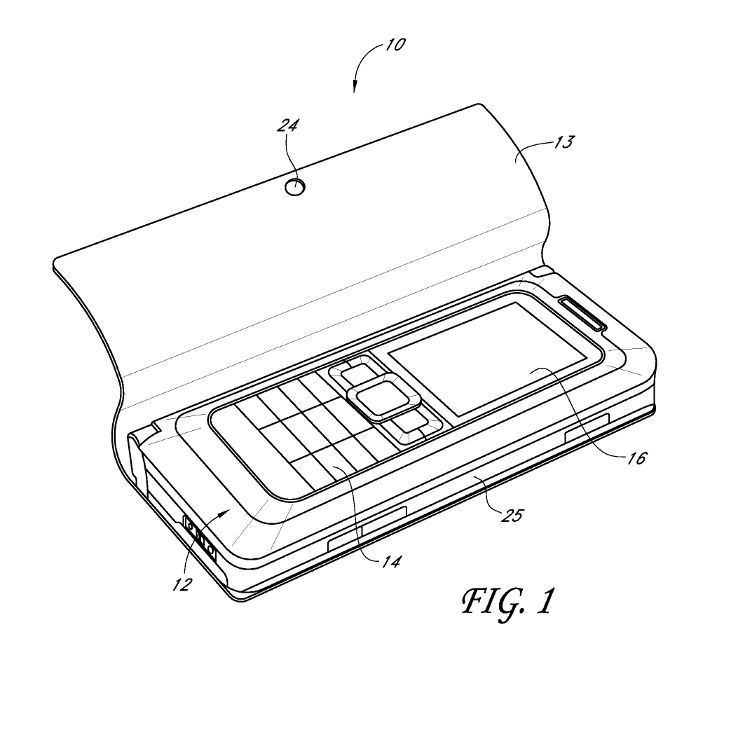

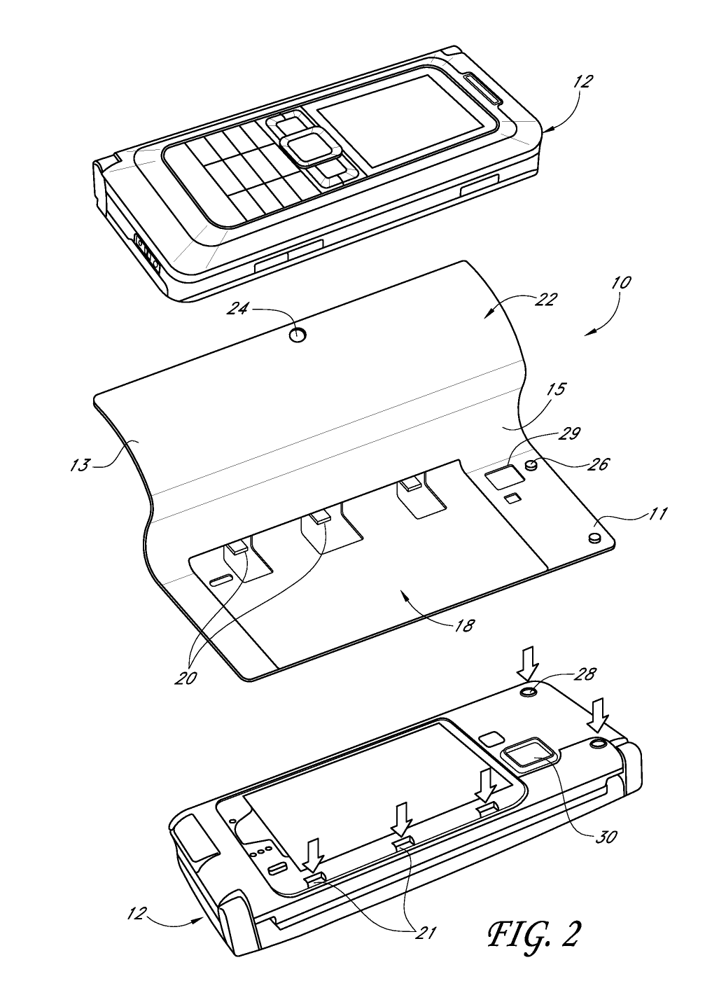

With reference to FIGS. 1 and 2, a mobile device accessory 10 can be used in conjunction with a mobile phone 12, which can include user interface surfaces, such as a keyboard portion 14 and display portion 16. The mobile device accessory 10 can comprise a cover, or case, for the mobile phone 12, and can substantially surround or cover some, all, or substantially all of the phone 12 to protect the phone 12 from environmental or user wear, or from inadvertent contact when not in use.

In the embodiment of FIGS. 1 and 2, a bottom side 11 of the mobile device accessory 10 removably contacts the phone 12 on a semi-permanent basis, and the top side 13 of the mobile device accessory 10 contacts the phone 12 when the phone 12 is not in use and opens away from the top side of the phone 12 when the phone 12 is in use. The mobile device accessory 10 can be made of any suitable material, such as plastic or leather. In some embodiments, the mobile device accessory 10 is entirely or partially flexible and in other embodiments it is entirely or partially rigid.

In the illustrated embodiment, the bottom and top portions 11, 13 of the mobile device accessory 10 are connected to each other by way of the flexible left sidewall 15. The bottom and top portions 11, 13 are generally unconnected from each other or open on the right side and upper and lower sides. In this way, the user can more easily access buttons on the right side and upper and lower sides of the phone, and the user can have direct, unobstructed access to the display 16 and keyboard 14 when the top portion 13 is moved out of the way as shown in FIG. 1. In some embodiments, all or a portion of the top side 13 of the mobile device accessory 10 can be transparent to permit viewing of the display 16 through the mobile device accessory 10.

The mobile device accessory 10 can include an attachment portion 18, which in some embodiments can resemble and/or be a replica of a removable component, such as a battery compartment cover for the phone 12. For example, the attachment portion 18 can comprise at least one tab 20 or a plurality of tabs 20 configured to mate with or engage slots 21 along the back of the phone 12 in a region of the phone 12 that is exposed when the removable component is taken off. In some embodiments, the attachment portion 18 can be used in place of the battery cover of the phone 12. The attachment portion 18 can be the same or substantially the same size as the original battery cover or it can be a different size but include certain connection structures (e.g. tabs 20) that are similar to those of the original battery cover so that the attachment portion 18 can be attached to the phone 12 in generally the same location and manner as the original battery cover. In some embodiments, the attachment portion 18 can be attached to various other components or areas of the phone 12. While the embodiment of FIGS. 1 and 2 uses tabs 20, other attachment structures or methods can also be used.

The attachment portion 18 can be comprised of, for example, plastic such as polypropylene, polyethylene terephthalate (PET), or other material substantially similar to that of the battery compartment cover of the phone 12. Other materials can also be used. In some embodiments, the attachment portion 18 can be comprised of the same material as the rest of the mobile device accessory. The attachment portion 18 can be attached to the mobile device accessory 10. For example, the attachment portion 18 can be attached by any suitable means, such as adhesives, thermal attachment methods, or mechanical fasteners or connectors. The attachment portion 18 can be attached to a region on the mobile device accessory 10 that is configured to be positioned against the mobile device 12 so that the attachment portion 18 is not readily visible on the outside of the connected mobile device accessory 10 and mobile device 12. In this way, the attachment portion 18 helps securely connect the mobile device accessory 10 to the mobile device 12 without changing the basic appearance of the mobile device accessory 10 and without adding substantial additional bulk or weight. In some embodiments, the attachment portion 18 can be integrally formed with the mobile device accessory 10.

The mobile device accessory 10 can include a thin, elastic and/or flexible accessory portion 22 configured to flex or bend around the phone 12 and substantially cover a portion or portions of the phone 12. The accessory portion 22 can be shaped such that it can fold over and cover the keyboard area 14 and display area 16 on the front surface of the phone 12. For example, the accessory portion 22 can comprise the left sidewall 15 and top portion 13. Other shapes are also possible, including but not limited to the shapes or contours of other types of mobile devices. The flexibility of the accessory portion 22 can vary. For example, in those embodiments in which the mobile device accessory is not a cover, the accessory portion 22 may not flex or may not exist.

The flexible accessory portion 22 as shown in FIGS. 1 and 2 can be flexible enough so that it can be folded back or moved back out of the way of the keyboard portion 14 or display portion 16 during use of the phone 12, without having to remove or detach the phone 12 from the mobile device accessory 10 (See, for example, FIG. 1). The accessory portion 22 can be made of, for example, a thin leather material, plastic, or elastic rubber. Other materials can also be used. In rigid cover embodiments, the accessory portion 22 can comprise a hinge and hard plastic top portion 13.

The accessory portion 22 can further comprise an attachment component 24, such as a magnet or button. The magnet 24, as shown in FIGS. 1 and 2, can be used to secure the accessory portion 22 to a side 25 (see FIG. 1) of the phone 12 or to the bottom side 11 of the mobile device accessory 10 when it is desired to have the top portion of the phone 12 securely covered, thereby helping to prevent the accessory portion 22 from folding back unintentionally.

The mobile device accessory 10 can further comprise one or more secondary attachments 26. In some embodiments, the secondary attachments 26 are located along either the accessory portion 22 or the attachment portion 18. The secondary attachments 26 can further aid in attaching or anchoring at least part of the mobile device accessory 10 to the phone 12. In some embodiments, the secondary attachments 26 are positioned on the same side of the mobile device accessory 10 as the attachment portion 18. As illustrated in FIG. 2, the secondary attachments 26 can comprise tabs which mate with holes and/or apertures 28 on the phone 12. In this way, the phone 12 can be more securely attached to the mobile device accessory 10 on a side of the phone 12 that does not include a display 16 and/or buttons. The bottom side 11 of the mobile device accessory 10 can further include an aperture 29 for permitting a communication device 30 (e.g. camera lens, microphone, speaker, etc.) to, for example, more easily receive light or transmit sound through the mobile device accessory 10.

In the embodiment illustrated in FIG. 1 and 2, the top side 13 and bottom side 11 of mobile device accessory 10 do not extend along the side walls of the phone 12 to secure the mobile device accessory 10 to the phone 12. This can provide a greater degree of unobstructed accessibility to the sides (e.g. side 25) of the phone 12, such as for charging and contacting buttons.

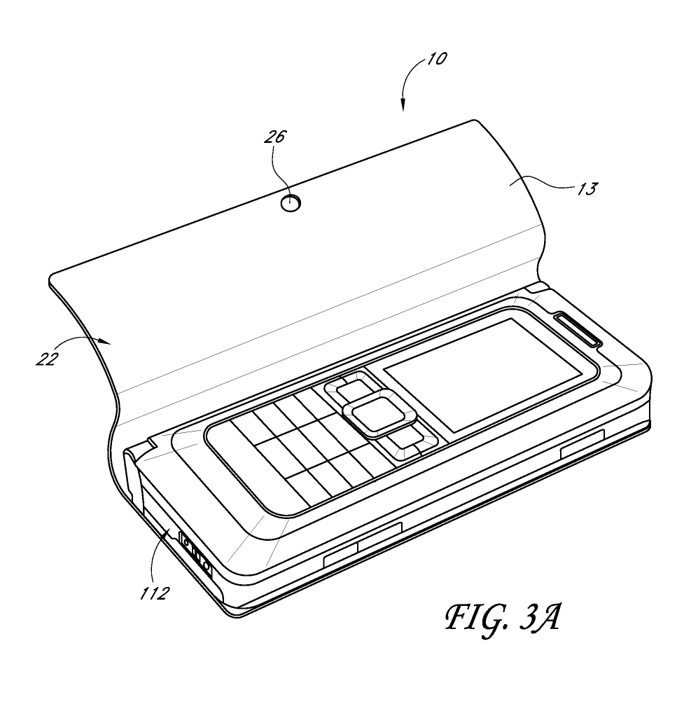

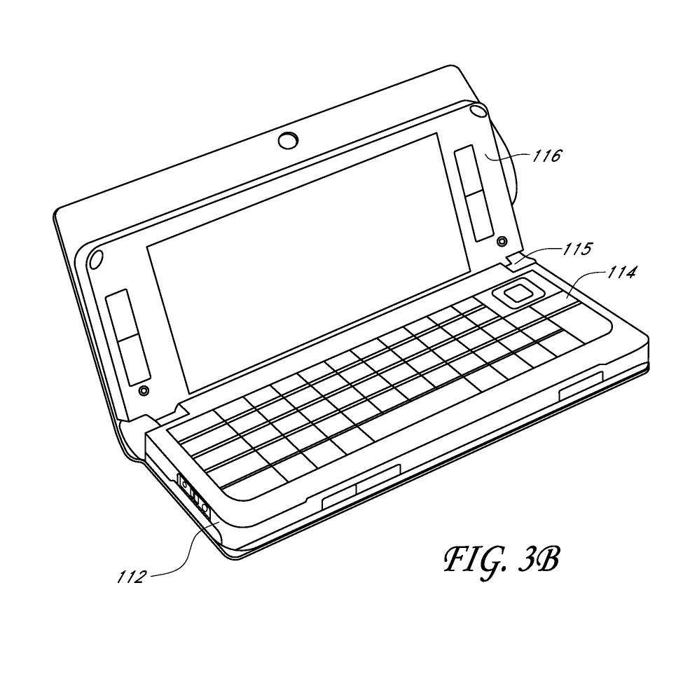

With reference to FIGS. 3A, 3B, and 4, a similar mobile device accessory 10 (e.g. a cover) can be used with other types of mobile devices, including those that open along a longitudinal back hinge 115, as shown in the mobile device 112 in FIG. 3B. The flexible accessory portion 22 of the mobile device accessory 10 can flex as the mobile device 112 is opened to reveal a keyboard portion 114 and display portion 116. In the illustrated embodiment, there is a connection between the top and bottom portions 13, 11 of the mobile device accessory 10 on the left side of the phone 112 (where the hinge on the phone 112 is located), but no connection between the top and bottom portions 13, 11 on the right side of the phone 112 (on the opposite side from this hinge). In this way, the mobile device accessory 10 can allow access to additional user components in the mobile device while still remaining attached to the mobile device 112 and providing protection to the rest of the mobile device 12. Conveniently, in contrast with other types of covers, it is not required for the user to remove the phone 112 from the mobile device accessory 10 in order to use the internally positioned keyboard 114. As shown in FIG. 4, the mobile device 112 can include retaining structures, such as slots 21 and apertures 28, to facilitate attachment with corresponding retaining structures, such as protrusions or tabs, on the mobile device accessory 10.

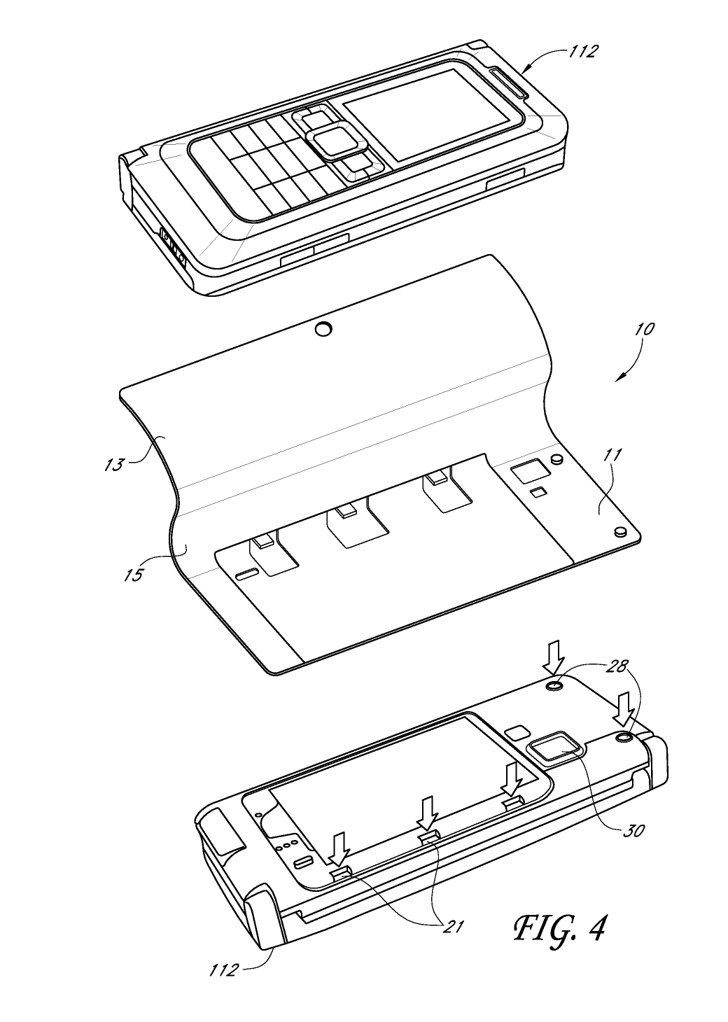

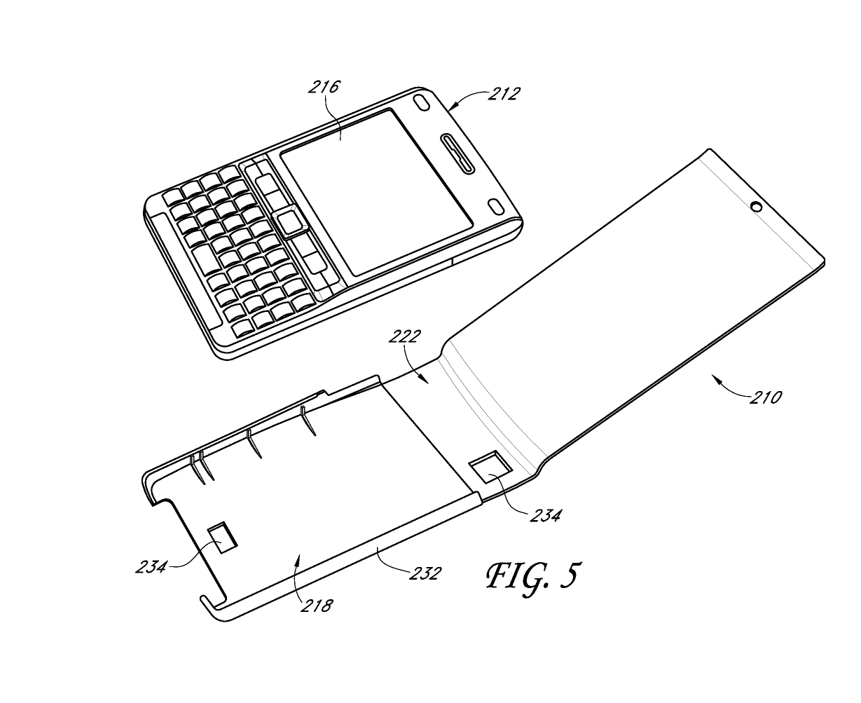

FIGS. 5 and 6 illustrate an embodiment of a mobile device accessory 210 configured for use with a mobile device 212. The mobile device accessory 210 can be similar in many respects to the mobile device accessory 10. Therefore, similar components of the mobile device accessory 210 are referenced by the same reference numeral as the corresponding component in the mobile device accessory 10 incremented by two hundred. As with the mobile device accessory 10, the mobile device accessory 210 can comprise an attachment portion 218 and an accessory portion 222.

In some embodiments, the mobile device 212 is a Blackberry® device or other similar mobile device. The mobile device accessory 210 can comprise an attachment portion 218, which in at least some embodiments can comprise a battery cover. As illustrated, the attachment portion 218 can be configured to cover a majority of the surface area of a back side portion of the device 212 when attached to the device 212. In some embodiments, the attachment portion 218 can include an elongated side ridge or ridges 232 configured to laterally wrap around or connect to at least a portion of the sidewalls of the device 212 to hold the mobile device accessory 210 in place against the device 212. In the illustrated embodiment, the ridges 232 do not extend onto a top surface of the device 212 in order to avoid interfering with the display 216 or input of information through the device 212. In some embodiments the ridges 232 can snap-fit onto the device 212 through use of an interference fit. Other forms and/or methods of attachment are also possible.

The mobile device accessory 210 can further include an opening or openings 234, which allow access to components of the device 212, such as for example an “on/off” switch or a button configured to release the original battery cover. In some embodiments, the openings 234 can be used to allow an antennae or other components or accessories (such as, for example, a power cord) of device 212 to extend through the mobile device accessory 210.

The device 212 can include a back side portion 236. The back side portion can comprise, for example, an area for attachment of the battery cover of the device 212. In some embodiments, a portion of the mobile device accessory 210 can be used as a replacement battery cover for the device 212.

The accessory portion 222 of the mobile device accessory 210 can be flexible enough to wrap around the top of the device 212 and extend over the keyboard and display areas, providing protection for the device 212 and inhibiting unwanted wear and tear on the device 212. Because the accessory portion 222 is flexible, it can also be folded back or moved back out of the way of the keyboard and display portions of the device 212 during use, without having to remove the mobile device accessory 210 entirely. A portion or portions of the accessory portion 222 can also be relatively rigid, providing a more sturdy covering and stronger protection for the device 212 than with some flexible materials.

As in the embodiments illustrated in FIGS. 1-4, the accessory portion 222 can be attached on a side of the attachment portion 218, rather than at a top side of the attachment portion 218, to permit the accessory portion 222 to open laterally rather than over the top of the device 212. As indicated at the beginning of this description, this is an example of how a feature of one illustrated embodiment is intended to be useable as an alternative configuration for another illustrated embodiment. All other features of each of the embodiments disclosed herein can also be combined or replaced in a similar manner.

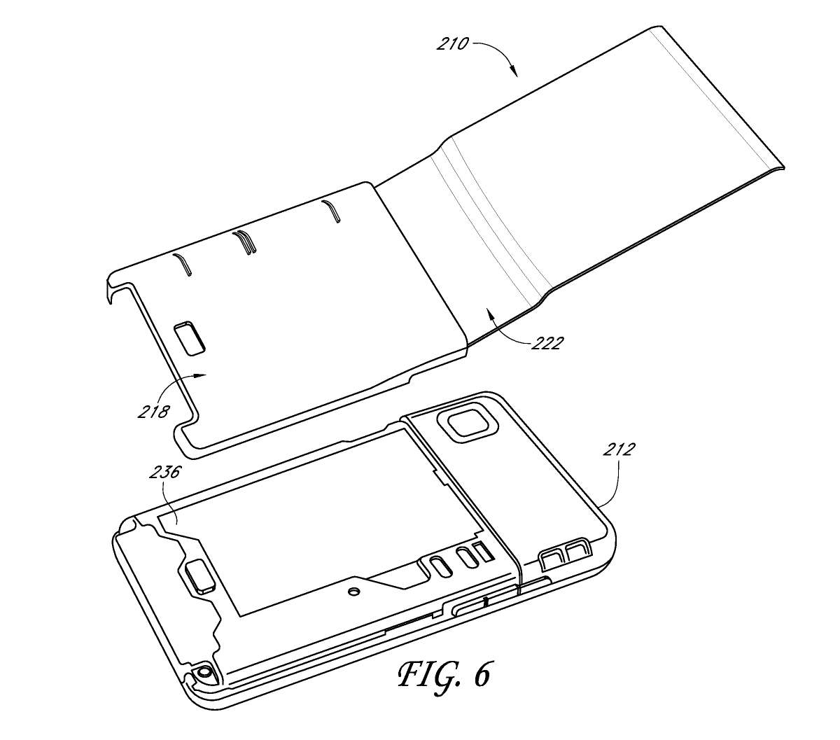

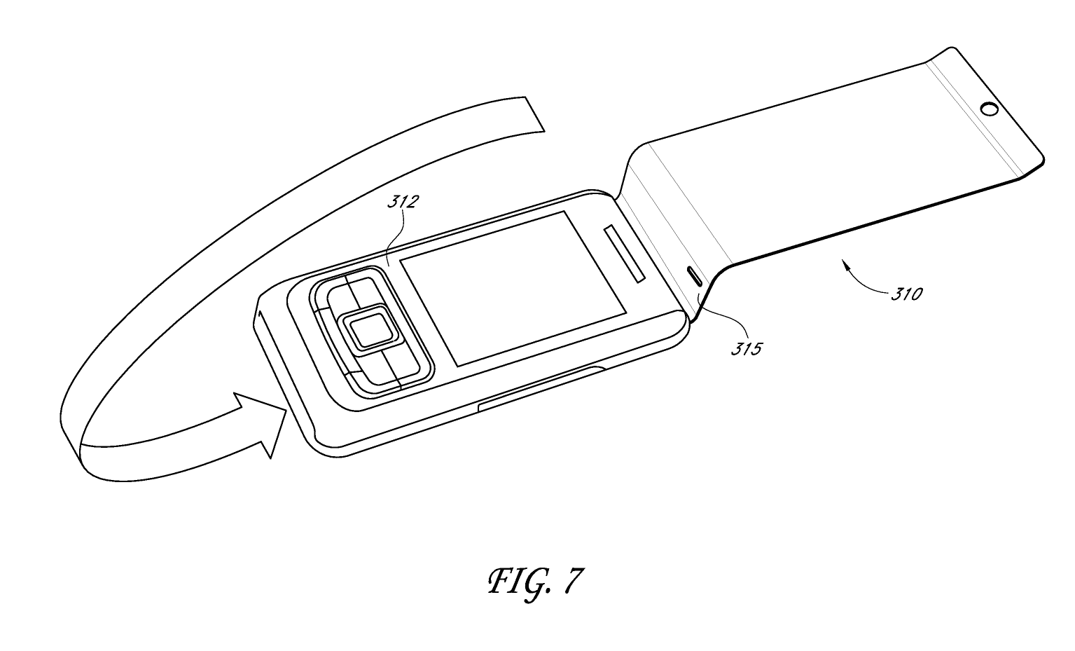

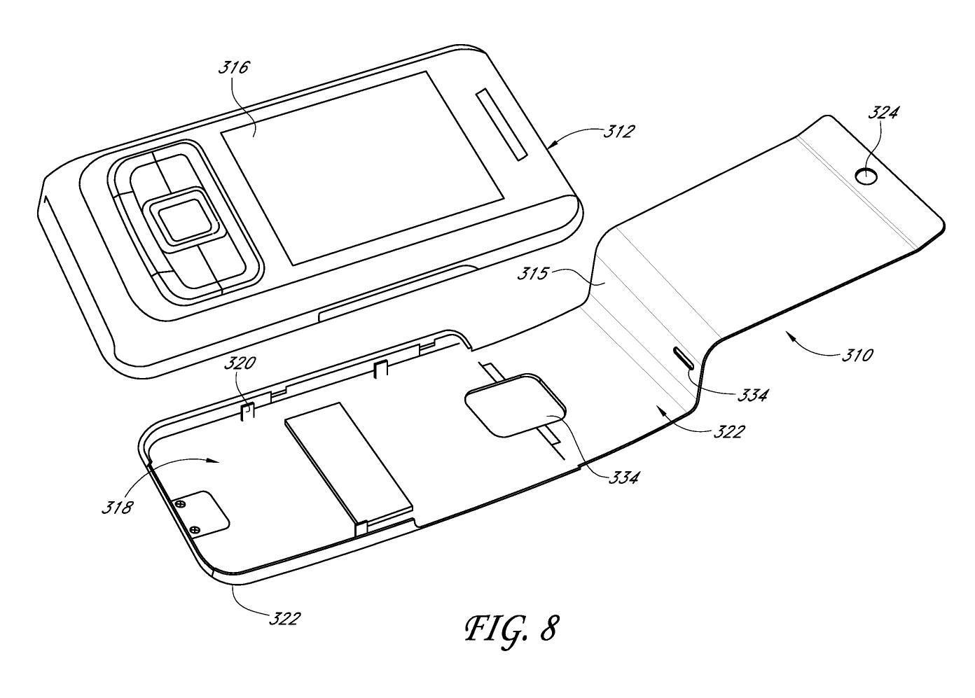

FIGS. 7, 8, and 9 illustrate an embodiment of a mobile device accessory 310 configured for use with another mobile device 312. The mobile device accessory 310 can be similar in many respects to the mobile device accessory 10. Therefore, similar components of the mobile device accessory 310 are referenced by the same reference numeral as the corresponding component in the mobile device accessory 10 incremented by three hundred. As with the mobile device accessory 10, the mobile device accessory 310 can comprise an attachment portion 318 and accessory portion 322.

In at least some embodiments, the mobile device 312 can comprise an essentially “keyless” mobile phone (e.g., a mobile phone without the traditional full telephone key pad). The mobile device accessory 310 can comprise an attachment portion 318, which in at least some embodiments can comprise a replacement for the original battery cover. The attachment portion 318 can comprise an elongated ridge or ridges 332 configured to wrap around and/or connect to the device 312. In the illustrated example, the ridge 332 is configured to extend along only the sidewalls and bottom portion of the device 312 to assist in holding the mobile device accessory 310 in place against the device 312. In other embodiments, the ridge 332 can extend along all four sides, or any one of the left, right, top, or bottom sides, or any combination thereof, as desired to secure the device 312 to a particular configuration of the mobile device accessory 310. The attachment portion 318 can also include tabs 320 or other additional attachment surfaces that are configured to mate with and/or engage with corresponding surfaces, such as slots 321 positioned along a back side of the phone 312.

The mobile device accessory 310 can further include an opening or openings 334, which allow access to components of the device 312, such as for example an “on/off” switch. In some embodiments, the openings 334 can be used to allow an antennae or other component of device 312 to extend through the mobile device accessory 310. The flexible accessory portion 322 of the mobile device accessory 310 can be flexible enough to wrap around the top of the device 312 and extend over the top of the device 312 to frontally contact the keyboard and display areas, thus providing protection for the device 312 and inhibiting unwanted wear and unintentional contact. Because the accessory portion 322 is flexible, it can be folded back or moved back out of the way of the keyboard and display portions of the device 312 during use, without having to remove the mobile device accessory 310 entirely. Alternatively, as in other embodiments, the accessory portion 322 can be more rigid and can include a hinge rather than a flexible bending region (e.g. a sidewall 315) to permit opening and closing.

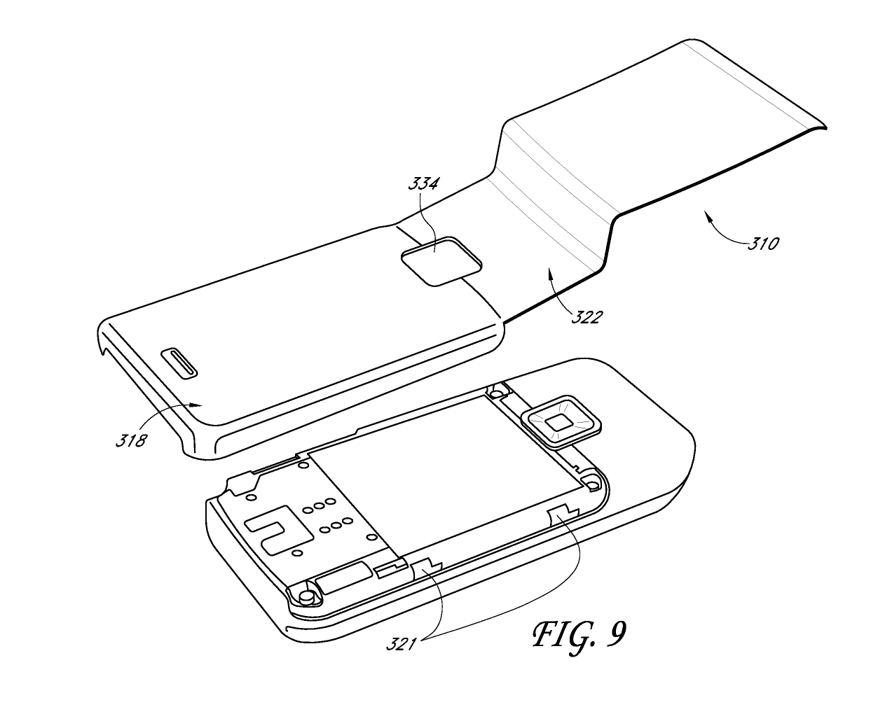

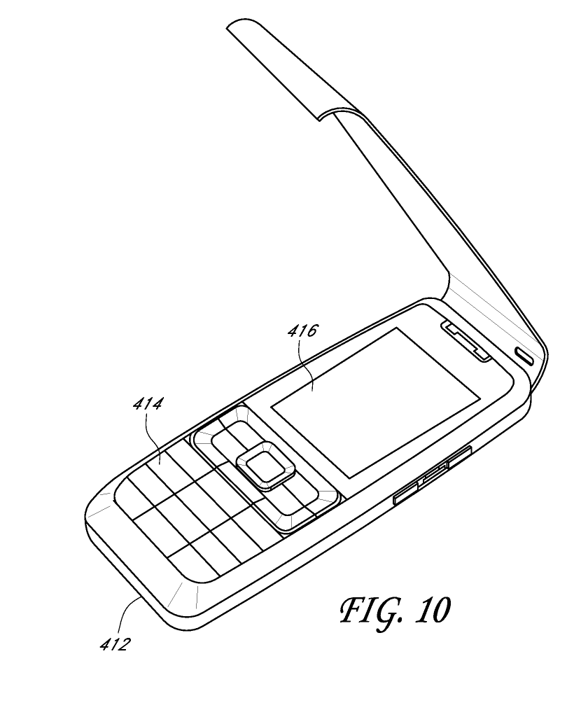

FIGS. 10 and 11 illustrate an embodiment of a mobile device accessory 410 configured for use with a mobile device 412. The mobile device accessory 410 can be similar in many respects to the mobile device accessory 10. Therefore, similar components of the mobile device accessory 410 are referenced by the same reference numeral as the corresponding component in the mobile device accessory 10 incremented by four hundred. As with the mobile device accessory 10, the mobile device accessory 410 can comprise an attachment portion 418 and accessory portion 422. In at least some embodiments, the mobile device 412 can comprise a mobile phone. The mobile device accessory 410 can comprise an attachment portion 418, which in at least some embodiments can comprise a battery cover replacement component. The mobile device accessory 410 can also include a flexible accessory portion 422, which can be substantially similar to that of the accessory portion 22 shown in FIG. 1, except that the flexible accessory portion 422 wraps around the top of the device 412 as opposed to the side of the device. The term “top of the device,” as used herein generally refers to that portion of the mobile device 412 adjacent the display portion 416 and covered by opening 434, as shown in FIG. 11.

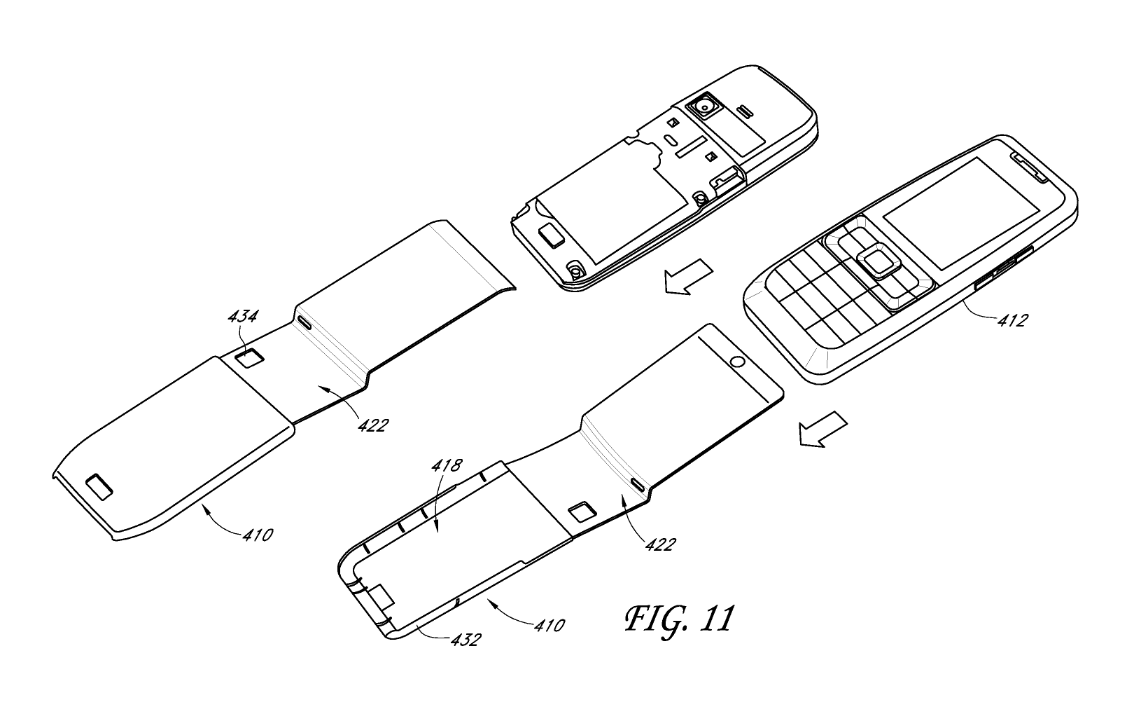

FIGS. 12, 13, and 14 illustrate an embodiment of a mobile device accessory 510 configured for use with a mobile device 512. The mobile device accessory 510 can be similar in many respects to the mobile device accessory 10. Therefore, similar components of the mobile device accessory 510 are referenced by the same reference numeral as the corresponding component in the mobile device accessory 10 incremented by five hundred. As with the mobile device accessory 10, the mobile device accessory 510 can comprise an attachment portion 518 and accessory portion 522.

With reference to FIGS. 12, 13, and 14, in at least some embodiments, the mobile device 512 can comprise an iPhone™ mobile device sold by Apple, Inc. The mobile device accessory 510 can comprise an attachment portion 518, which in at least some embodiments can comprise a battery cover replacement component. In some embodiments, the attachment portion 518 can comprise a slip cover which fits over an end of the iPhone™ or other mobile device. The attachment portion 518 can comprise an aperture 529 for access to a communications device 530 (e.g. a USB port). In some embodiments, such as those illustrated in FIGS. 5-11, the attachment portion can form a substantial portion of the mobile device accessory 10. For example, the attachment portion can be nearly half or about half of the size of the overall mobile device accessory 10. In some embodiments, such as that illustrated in FIGS. 12-15, the attachment portion can be small as compared to the overall mobile device accessory 10.

The mobile device accessory 510 can also include a flexible or rigid accessory portion 522. The accessory portion 522 of the mobile device accessory 510 can be flexible enough to wrap around the top of the device 512 and extend over the “keyboard” and display areas, thus providing protection for the device 512 and inhibiting unwanted wear and unintentional contact. The accessory portion 522 can be folded back or moved back out of the way of the keyboard and display portions of the device 512 during use, without having to remove the mobile device accessory 310 entirely.

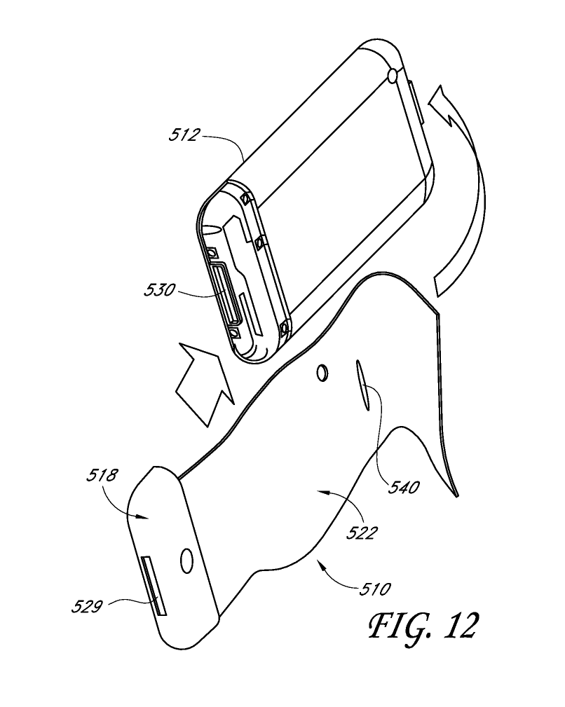

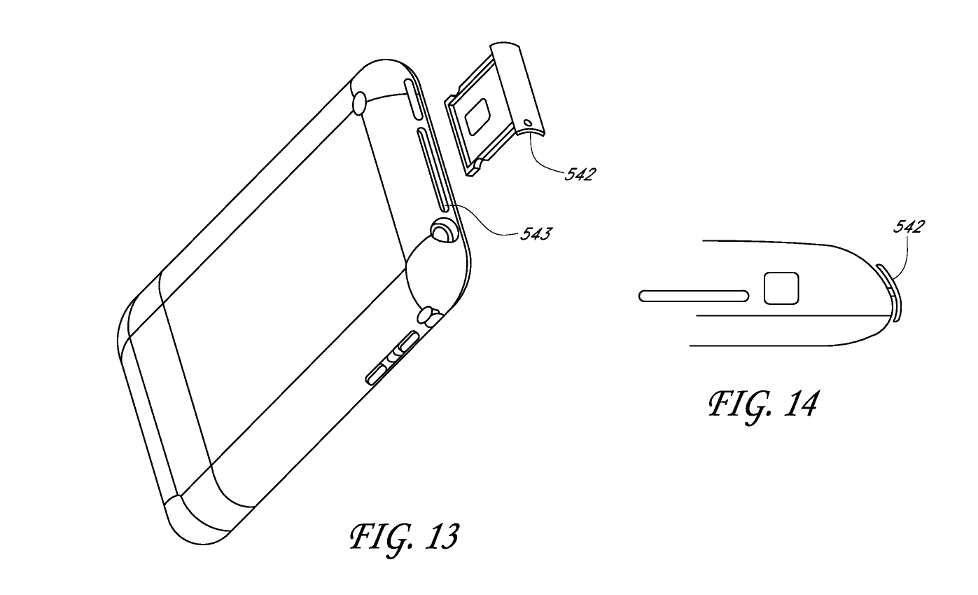

In some embodiments, the mobile device accessory 510 can additionally include a secondary securing structure, such as retaining opening 540. The retaining opening 540 can be used in conjunction with, a retaining device 542 (e.g. SIM card holder) as shown in FIGS. 13 and 14. The SIM card holder 542, and/or another mobile device component, can be removed prior to attachment of the mobile device accessory 510 to the device 512. Once the mobile device accessory 510 is attached to the device 512 via the attachment portion 518, the SIM card holder can be placed into an opening 543 in the device 512 through the retaining opening 540. As shown in FIG. 14, once installed, the SIM card holder 542 can facilitate retention of at least a portion of the mobile device accessory 510 against the device 512. In other appropriately configured embodiments, a replica replacement SIM card holder can be integrated into or otherwise attached to the mobile device accessory 510.

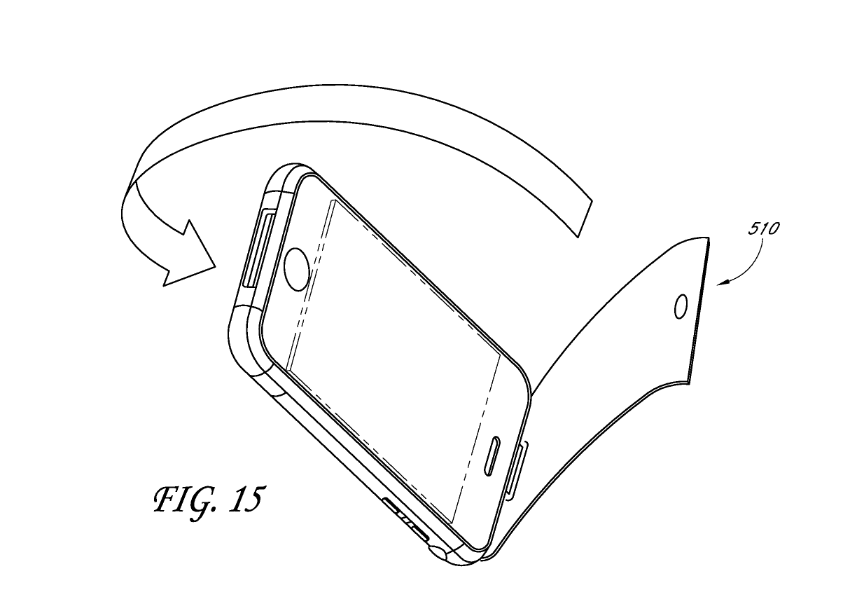

With reference to FIG. 15, in some embodiments, this added retaining feature can allow the mobile device accessory 510 to flex back only so far as the retaining opening 540, thereby keeping at least some of the flexible accessory portion 522 in close contact with the device 512, while allowing the rest of the flexible portion 522 to bend and flex away from the device 512.

The attachment portion 518 in this and all other embodiments can be configured to be shaped, sized, and/or contoured so as to match the original component being essentially replaced by the attachment portion to give the appearance that the mobile device 512 still has its essential original shape. This permits the device 512, when attached with the mobile device accessory 510, to continue to have a low profile and to not become substantially bulky or heavy.

While the embodiments described above incorporate the use of a battery cover or replica battery cover, other embodiments can include and/or incorporate other or additional mobile device components. For example, in at least some embodiments the mobile device accessories can include attachment portions which are replica memory card covers, replica antennae, or other structures.

Additionally, while the embodiments described above all comprise a flexible accessory portion in the form of a component which can cover a display and/or keyboard, in other embodiments the mobile device accessories can comprise other types of accessory portions. For example, the accessory portion of the mobile device accessory can comprise a mount, or mounting system, which is attachable to a belt, user, or some other device. These accessory portions can be attached to the mobile device in a manner similar to or the same as other accessory portions illustrated and described in this application or in other ways. In some embodiments, these types of accessory portions can provide an easy way to prevent loss of the mobile device itself, and/or keep the mobile device from moving, shifting, or being inadvertently contacted. Other accessory portions can also be used.

Attachment of the above-described mobile device accessories to the mobile device can be made quickly, safely, and with relative ease. For example, and in at least some embodiments, to replace or add a mobile device accessory, the current mobile accessory device can be removed just as one would remove a battery cover on the back of a mobile device. Once the original mobile device accessory has been removed, a new one can conveniently be attached in its place by, for example, snapping it into place on the back of the mobile device's battery compartment.

In at least some embodiments, the mobile device accessories can protect the entire mobile device, even if the mobile device requires opening or closing of a cover, part, and/or other components. For example, many mobile phones have a hinged lid, display portion, or other component which flips open when the phone is in use, and remains closed when the phone is not in use. The mobile device accessories described above can protect the outer surfaces of the phone while the phone is not in use, including these hinged portions. When the hinged portions are opened, the accessory portions of the mobile accessory devices can flex and/or bend to allow access to areas such as the keyboard and display areas of the phone, without having to remove and/or detach the mobile device accessories from the phones.

Further, many current mobile device covers cover a portion or all of the keyboard and display areas with semi-transparent plastic or other material, often making these areas difficult to use and/or see. By leaving the keyboard and display portions uncovered as described above, and/or allowing the accessory portion to flex away from these areas during use, the user can have direct access to the keyboard and display areas during use of the mobile device.

Further, the mobile device accessories described above can be lightweight and compact, and in at least some embodiments can be fastened to not only the battery compartment, but also to other areas of the mobile device without use of fasteners. For example, the mobile device accessories can incorporate the use of mobile device components, such as a SIM card holder, to help secure the accessory portions in place in one or more areas along the mobile device. As described above, the SIM card holder can be used to secure part of the accessory portion along the top of a mobile device, thus allowing the accessory portion to flex in a limited manner about the top of the device.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions.

It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

This is claimed:

1. A mobile device accessory for use with a mobile device, the mobile device accessory comprising:
a flexible accessory portion configured to selectively cover and uncover one or more user interface surfaces on a mobile device; and
an attachment portion comprising a replica mobile device component, the attachment portion configured to be attached to the mobile device where a corresponding original mobile device component is normally located.

2. The mobile device accessory of claim 1, wherein the accessory portion comprises openings for user interface surfaces.

3. The mobile device accessory of claim 1, wherein the accessory portion is configured to selectively cover and uncover a mobile phone.

4. The mobile device accessory of claim 1, wherein the replica mobile device component comprises a replica battery compartment cover.

5. The mobile device accessory of claim 1, wherein the accessory portion comprises a retaining opening for the insertion of a retaining device into the mobile device.

6. The mobile device accessory of claim 5, wherein the retaining device is a SIM card holder configured to be placed through the retaining opening and into an opening of the mobile device.

7. The mobile device accessory of claim 1, wherein at least a part of the accessory portion can be flexed away from the user interface surfaces of the mobile device to provide access to the keyboard and display, without entirely removing the accessory device from the mobile device.

8. The mobile device accessory of claim 1, wherein the accessory portion comprises an attachment component, the attachment component configured to secure the accessory portion to the mobile device.

9. The mobile device accessory of claim 8, wherein the attachment component comprises a magnet.

10. A method for attaching a mobile device accessory, the mobile device accessory comprising an attachment portion and a flexible accessory portion, comprising:
removing an original mobile device component from a mobile device;
attaching the attachment portion of the mobile accessory device to a location where the original mobile device component was previously attached; and
wrapping the accessory portion around at least a portion of the mobile device such that the accessory portion covers and protects at least one user interface surface.

11. The method of claim 10, further comprising removably securing the accessory portion to the mobile device using a magnet located on an end of the accessory portion.

12. The method of claim 10, wherein the attachment portion comprises a replica battery compartment.

13. The method of claim 10, wherein the original mobile device component comprises a battery compartment.

14. The method of claim 10, further comprising securing a portion of the accessory portion to the mobile device by inserting a retaining device through a retaining opening in the accessory portion and into an opening in the mobile device.

15. The method of claim 14, wherein the retaining device comprises a SIM card.
